(19) United States
(12) Patent Application Publication
(10) Pub. No.: US 2025/0083963 A1
(43) Pub. Date: Mar. 13, 2025

(54) SULFUR-DOPED NANO CARBON SYNTHESIS FROM PETROLEUM FEEDSTOCKS

(71) Applicant: Saudi Arabian Oil Company, Dhahran (SA)

(72) Inventors: Wala Algozeeb, Dhahran (SA); Noha Al-Shihri, Khobar (SA)

(21) Appl. No.: 18/465,597

(22) Filed: Sep. 12, 2023

(51) Int. Cl. C01B 32/15

(52) U.S. Cl. CPC C01B 32/15; C01P 2002/85; C01P 2004/03; C01P 2006/80

(57) ABSTRACT

This disclosure relates to methods of thermal carbonization, including heating a petroleum feedstock and a carbonization catalyst to form a sulfur-doped carbon product.

### TECHNICAL FIELD

This document relates to methods of thermal carbonization, including heating a petroleum feedstock and a carbonization catalyst to form a sulfur-doped carbon product.

### BACKGROUND

Petroleum feedstocks may be used for noncombustible applications, such as raw materials for advanced material synthesis. However, low-value petroleum feedstocks, such as vacuum cuts (including atmospheric residue, light vacuum gas oil (VGO), heavy vacuum gas oil (VGO), and vacuum residue) from a refinery are challenging to refine due to the high concentration of contaminants, such as sulfur, metals, and asphaltene. If not removed, these contaminates may poison catalysts, cause catalyst coking, or result in the production of low-quality high-sulfur products. As such, vacuum cuts require careful processing and treatment to remove contaminants prior to conversion to more valuable products (FIG. 1), such as sulfur-doped carbon, which has applications in energy storage and carbon dioxide capture.

Thermal cracking is a method of converting long chain hydrocarbons, such as those contained in a petroleum feedstock, to shorter chain hydrocarbons. Thermal cracking may be achieved through thermal carbonization, which is a method of forming solid carbon products from hydrocarbons to form structured, solid carbon products for use in other applications. Thermal carbonization may be an energy-intensive process, requiring high temperatures and/or high pressures to convert the feedstock materials to the desired carbon products.

Previously reported thermal carbonization processes utilize potassium hydroxide as a carbonization catalyst. However, potassium hydroxide is corrosive and difficult to use on large industrial scale. Previously reported thermal carbonization methods require multiple processing steps, high temperatures and pressures, and extended reaction times. Therefore, there is a need to develop new methods of thermal carbonization.

### SUMMARY

Provided in the present disclosure are methods of thermal carbonization, including:
heating a petroleum feedstock and a carbonization catalyst to a carbonization temperature to form a sulfur-doped carbon;
where the petroleum feedstock includes one or more sulfur-containing compounds, and the carbonization catalyst is an acetate, a bicarbonate, a bromide, a carbonate, a chloride, a fluoride, an oxalate salt, or a combination thereof.

In some embodiments, the carbonization catalyst is potassium acetate, potassium bicarbonate, potassium carbonate, potassium chloride, potassium oxalate, calcium acetate, calcium bicarbonate, calcium carbonate, calcium chloride, calcium oxalate, sodium acetate, sodium bicarbonate, sodium carbonate, sodium chloride, sodium oxalate, sodium fluoride, potassium fluoride, sodium bromide, potassium bromide, or a combination thereof.

In some embodiments, the carbonization catalyst is potassium acetate, potassium bicarbonate, potassium carbonate, potassium chloride, potassium oxalate, or a combination thereof.

In some embodiments, the carbonization catalyst is potassium carbonate.

In some embodiments, about 0.25 equivalents to about 4.00 equivalents of carbonization catalyst are used relative to the petroleum feedstock.

In some embodiments, about 1.00 equivalents of carbonization catalyst are used relative to the petroleum feedstock.

In some embodiments, the carbonization temperature is about 450° C. to about 800° C.

In some embodiments, the carbonization temperature is about 500° C. to about 700° C.

In some embodiments, the petroleum feedstock and the carbonization catalyst are heated to the carbonization temperature for about 5 min to about 240 min.

In some embodiments, the petroleum feedstock and the carbonization catalyst are heated to the carbonization temperature for about 40 min.

In some embodiments, the petroleum feedstock and the carbonization catalyst are heated at a pressure of about 1 bar.

In some embodiments, the sulfur-doped carbon is formed in a yield of about 5% to about 50%.

In some embodiments, the sulfur-doped carbon is formed in a yield of about 10% to about 30%.

In some embodiments, the sulfur-doped carbon is formed in a yield of about 10% to about 20%.

In some embodiments, the sulfur-doped carbon has a sulfur-content of about 0.1 wt % to about 20.00%.

In some embodiments, the sulfur-doped carbon has a sulfur-content of about 0.50 wt % to about 15.00 wt %.

In some embodiments, the sulfur-doped carbon has a sulfur-content of about 1.00 wt % to about 10.00 wt %.

In some embodiments, the petroleum feedstock and the carbonization catalyst are heated in the presence of one or more additives, selected from potassium chloride, potassium hydroxide, elemental sulfur, or a combination thereof.

In some embodiments, the additive is potassium chloride, potassium hydroxide, or a combination thereof.

In some embodiments, the additive is elemental sulfur, and the sulfur-doped carbon includes a higher sulfur content compared to the sulfur-doped carbon formed when the petroleum feedstock and the carbonization catalyst are heated without elemental sulfur.

In some embodiments, the petroleum feedstock includes one or more of atmospheric residue, light vacuum gas oil (VGO), heavy vacuum gas oil (VGO), and vacuum residue.

Further provided in the present disclosure are methods of thermal carbonization, the method including:
providing a petroleum feedstock in a vessel;
heating the petroleum feedstock to a pour point temperature;
adding a carbonization catalyst to the petroleum feedstock;
purging oxygen from the vessel with nitrogen;
heating the petroleum feedstock and carbonization catalyst to a carbonization temperature to form a sulfur-doped carbon;
isolating the sulfur-doped carbon;
washing the sulfur-doped carbon to provide a purified sulfur-doped carbon;
where the petroleum feedstock includes one or more sulfur-containing compounds, and the carbonization catalyst is an acetate, bicarbonate, carbonate, chloride, or oxalate salt, or a combination thereof.

In some embodiments, the pour point temperature is about 25° C. to about 100° C.

In some embodiments, the pour point temperature is about 40° C.

In some embodiments, the method further includes regenerating the carbonization catalyst.

### DESCRIPTION OF DRAWINGS

FIG. 1 shows an exemplary refinery schematic showing the processing and treatment of petroleum feedstocks.

FIG. 2 shows a diagram of the reactor utilized for a thermal carbonization process.

FIG. 3A shows a scanning electron microscope (SEM) image of the sulfur-doped carbon sample, showing the porous structure, from atmospheric residue feedstock.

FIG. 3B shows a scanning electron microscope (SEM) image of the sulfur-doped carbon sample, showing the porous structure, from atmospheric residue feedstock at increased magnification.

FIG. 4 shows a scanning electron microscope (SEM) image of the sulfur-doped carbon sample, showing the porous structure, from vacuum residue feedstock.

FIG. 5 shows an energy dispersive (EDS) X-ray spectrum of the sulfur-doped carbon sample from atmospheric residue feedstock. The EDS spectrum shows that the sulfur-doped carbon sample contains between about 1-5 wt % sulfur content.

FIG. 6 shows an energy dispersive (EDS) X-ray spectrum of the sulfur-doped carbon sample from vacuum residue feedstock. The EDS spectrum shows that the sulfur-doped carbon sample contains between about 4-10 wt % sulfur content.

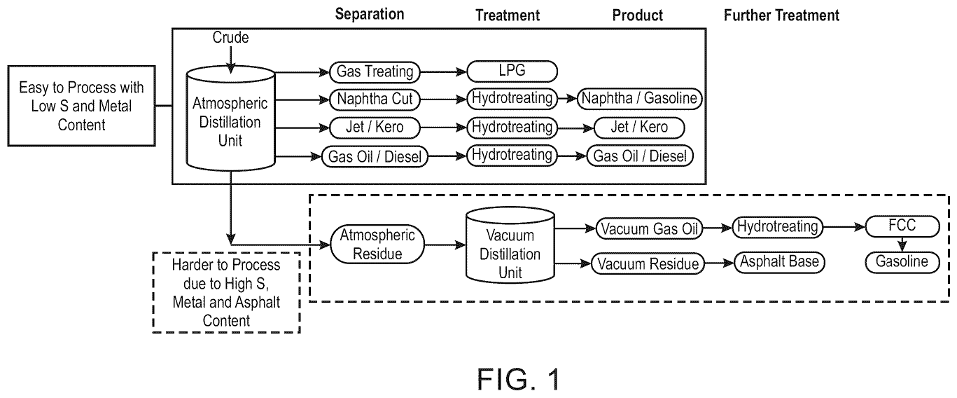

### DETAILED DESCRIPTION

The present disclosure relates to methods of thermal carbonization for petroleum feedstocks. In some embodiments, the method includes heating a petroleum feedstock and a carbonization catalyst to form a sulfur-doped carbon. In some embodiments, the petroleum feedstock includes one or more sulfur-containing compounds, and the carbonization catalyst is an acetate, a bicarbonate, a bromide, a carbonate, a chloride, a fluoride, an oxalate salt, or a combination thereof.

In some embodiments, the use of a carbonization catalyst enables the thermal carbonization of petroleum feedstocks containing a high concentration of contaminants. In some embodiments, the use of a carbonization catalyst enables the thermal carbonization of low-quality petroleum feedstocks. In some embodiments, the use of a carbonization catalyst enables the thermal carbonization of vacuum cuts (including atmospheric residue, light vacuum gas oil (VGO), heavy vacuum gas oil (VGO), and vacuum residue). In some embodiments, the use of a carbonization catalyst enables the thermal carbonization of sulfur-rich petroleum feedstocks. In some embodiments, the use of a carbonization catalyst enables the thermal carbonization of petroleum feedstocks while requiring no pretreatment or pre-processing of the petroleum feedstock. In some embodiments, the use of a carbonization catalyst enables the thermal carbonization of petroleum feedstocks while requiring minimal pretreatment or pre-processing of the petroleum feedstock. In some embodiments, the use of a carbonization catalyst enables the thermal carbonization of sulfur-rich petroleum feedstocks to form sulfur-doped carbon, which has advanced applications in energy storage and CO₂ capture.

The disclosed methods, which use an acetate, a bicarbonate, a bromide, a carbonate, a chloride, a fluoride, an oxalate salt, or a combination thereof as the carbonization catalyst may result in shorter heating times for thermal carbonization methods than thermal carbonization methods performed without a carbonization catalyst or with a hydroxide salt as the carbonization catalyst. In some embodiments, the use of a carbonization catalyst may result in thermal carbonization methods requiring one process step.

The present disclosure relates to methods of thermal carbonization, the method including:
heating a petroleum feedstock and a carbonization catalyst to a carbonization temperature to form a sulfur-doped carbon;
where the petroleum feedstock includes one or more sulfur-containing compounds, and the carbonization catalyst is an acetate, a bicarbonate, a bromide, a carbonate, a chloride, a fluoride, an oxalate salt, or a combination thereof.

In some embodiments, the carbonization catalyst is an acetate. In some embodiments, the carbonization catalyst is a bicarbonate. In some embodiments, the carbonization catalyst is a bromide. In some embodiments, the carbonization catalyst is a carbonate. In some embodiments, the carbonization catalyst is a chloride. In some embodiments, the carbonization catalyst is a fluoride. In some embodiments, the carbonization catalyst is an oxalate salt.

In some embodiments, the carbonization catalyst is potassium acetate. In some embodiments, the carbonization catalyst is potassium bicarbonate. In some embodiments, the carbonization catalyst is potassium carbonate. In some embodiments, the carbonization catalyst is potassium chloride.

In some embodiments, the carbonization catalyst is potassium acetate, potassium bicarbonate, potassium carbonate, potassium chloride, potassium oxalate, calcium acetate, calcium bicarbonate, calcium carbonate, calcium chloride, calcium oxalate, sodium acetate, sodium bicarbonate, sodium carbonate, sodium chloride, sodium oxalate, sodium fluoride, potassium fluoride, sodium bromide, potassium bromide, or a combination thereof. In some embodiments, the carbonization catalyst is potassium oxalate. In some embodiments, the carbonization catalyst is calcium acetate. In some embodiments, the carbonization catalyst is calcium bicarbonate. In some embodiments, the carbonization catalyst is calcium carbonate. In some embodiments, the carbonization catalyst is calcium chloride. In some embodiments, the carbonization catalyst is calcium oxalate. In some embodiments, the carbonization catalyst is sodium acetate. In some embodiments, the carbonization catalyst is sodium bicarbonate. In some embodiments, the carbonization catalyst is sodium carbonate. In some embodiments, the carbonization catalyst is sodium chloride. In some embodiments, the carbonization catalyst is sodium oxalate. In some embodiments, the carbonization catalyst is sodium fluoride. In some embodiments, the carbonization catalyst is potassium fluoride. In some embodiments, the carbonization catalyst is sodium bromide. In some embodiments, the carbonization catalyst is potassium bromide.

In some embodiments, the carbonization catalyst is potassium acetate, potassium bicarbonate, potassium carbonate, potassium chloride, potassium oxalate, or a combination thereof.

In some embodiments, the carbonization catalyst is potassium carbonate.

In some embodiments, about 0.25 equivalents to about 4.00 equivalents of carbonization catalyst are used relative to the petroleum feedstock. In some embodiments, about 0.50 equivalents to about 3.00 equivalents of carbonization catalyst are used relative to the petroleum feedstock. In some embodiments, about 0.75 equivalents to about 2.00 equivalents of carbonization catalyst are used relative to the petroleum feedstock. In some embodiments, about 1.00 equivalents to about 1.50 equivalents of carbonization catalyst are used relative to the petroleum feedstock.

In some embodiments, about 0.25 equivalents to about 3.50 equivalents of carbonization catalyst are used relative to the petroleum feedstock. In some embodiments, about 0.25 equivalents to about 3.00 equivalents of carbonization catalyst are used relative to the petroleum feedstock. In some embodiments, about 0.25 equivalents to about 2.50 equivalents of carbonization catalyst are used relative to the petroleum feedstock. In some embodiments, about 0.25 equivalents to about 2.00 equivalents of carbonization catalyst are used relative to the petroleum feedstock. In some embodiments, about 0.25 equivalents to about 1.50 equivalents of carbonization catalyst are used relative to the petroleum feedstock. In some embodiments, about 0.25 equivalents to about 1.00 equivalents of carbonization catalyst are used relative to the petroleum feedstock. In some embodiments, about 0.25 equivalents to about 0.50 equivalents of carbonization catalyst are used relative to the petroleum feedstock.

In some embodiments, about 0.50 equivalents to about 4.00 equivalents of carbonization catalyst are used relative to the petroleum feedstock. In some embodiments, about 1.00 equivalents to about 4.00 equivalents of carbonization catalyst are used relative to the petroleum feedstock. In some embodiments, about 1.50 equivalents to about 4.00 equivalents of carbonization catalyst are used relative to the petroleum feedstock. In some embodiments, about 2.00 equivalents to about 4.00 equivalents of carbonization catalyst are used relative to the petroleum feedstock. In some embodiments, about 2.50 equivalents to about 4.00 equivalents of carbonization catalyst are used relative to the petroleum feedstock. In some embodiments, about 3.00 equivalents to about 4.00 equivalents of carbonization catalyst are used relative to the petroleum feedstock. In some embodiments, about 3.50 equivalents to about 4.00 equivalents of carbonization catalyst are used relative to the petroleum feedstock.

In some embodiments, about 0.25 equivalents of carbonization catalyst are used relative to the petroleum feedstock. In some embodiments, about 0.50 equivalents of carbonization catalyst are used relative to the petroleum feedstock. In some embodiments, about 0.75 equivalents of carbonization catalyst are used relative to the petroleum feedstock. In some embodiments, about 1.00 equivalents of carbonization catalyst are used relative to the petroleum feedstock. In some embodiments, about 1.25 equivalents of carbonization catalyst are used relative to the petroleum feedstock. In some embodiments, about 1.50 equivalents of carbonization catalyst are used relative to the petroleum feedstock. In some embodiments, about 1.75 equivalents of carbonization catalyst are used relative to the petroleum feedstock. In some embodiments, about 2.00 equivalents of carbonization catalyst are used relative to the petroleum feedstock. In some embodiments, about 2.25 equivalents of carbonization catalyst are used relative to the petroleum feedstock. In some embodiments, about 2.50 equivalents of carbonization catalyst are used relative to the petroleum feedstock. In some embodiments, about 2.75 equivalents of carbonization catalyst are used relative to the petroleum feedstock. In some embodiments, about 3.00 equivalents of carbonization catalyst are used relative to the petroleum feedstock. In some embodiments, about 3.25 equivalents of carbonization catalyst are used relative to the petroleum feedstock. In some embodiments, about 3.50 equivalents of carbonization catalyst are used relative to the petroleum feedstock. In some embodiments, about 3.75 equivalents of carbonization catalyst are used relative to the petroleum feedstock. In some embodiments, about 4.00 equivalents of carbonization catalyst are used relative to the petroleum feedstock.

In some embodiments, about 0.50 equivalents to about 1.50 equivalents of carbonization catalyst are used relative to the petroleum feedstock. In some embodiments, about 0.75 equivalents to about 1.25 equivalents of carbonization catalyst are used relative to the petroleum feedstock. In some embodiments, about 0.90 equivalents to about 1.10 equivalents of carbonization catalyst are used relative to the petroleum feedstock.

In some embodiments, the carbonization temperature is from about 450° C. to about 800° C. In some embodiments, the carbonization temperature is from about 450° C. to about 750° C. In some embodiments, the carbonization temperature is from about 500° C. to about 700° C. In some embodiments, the carbonization temperature is from about 550° C. to about 650° C. In some embodiments, the carbonization temperature is from about 600° C. to about 650° C. In some embodiments, the carbonization temperature is from about 550° C. to about 600° C.

In some embodiments, the carbonization temperature is from about 450° C. to about 750° C. In some embodiments, the carbonization temperature is from about 450° C. to about 700° C. In some embodiments, the carbonization temperature is from about 450° C. to about 650° C. In some embodiments, the carbonization temperature is from about 450° C. to about 600° C. In some embodiments, the carbonization temperature is from about 450° C. to about 550° C. In some embodiments, the carbonization temperature is from about 450° C. to about 500° C.

In some embodiments, the carbonization temperature is from about 450° C. to about 800° C. In some embodiments, the carbonization temperature is from about 500° C. to about 800° C. In some embodiments, the carbonization temperature is from about 550° C. to about 800° C. In some embodiments, the carbonization temperature is from about 600° C. to about 800° C. In some embodiments, the carbonization temperature is from about 650° C. to about 800° C. In some embodiments, the carbonization temperature is from about 700° C. to about 800° C. In some embodiments, the carbonization temperature is from about 750° C. to about 800° C.

In some embodiments, the carbonization temperature is from about 500° C. to about 700° C.

In some embodiments, the carbonization temperature is about 450° C., about 500° C., about 550° C., about 600° C., about 650° C., about 700° C., about 750° C., or about 800° C. In some embodiments, the carbonization temperature is about 450° C. In some embodiments, the carbonization temperature is about 550° C. In some embodiments, the carbonization temperature is about 600° C. In some embodiments, the carbonization temperature is about 650° C. In some embodiments, the carbonization temperature is about 700° C. In some embodiments, the carbonization temperature is about 750° C. In some embodiments, the carbonization temperature is about 800° C.

In some embodiments, the petroleum feedstock and the carbonization catalyst are heated to the carbonization temperature for from about 5 min to about 240 min. In some embodiments, the petroleum feedstock and the carbonization catalyst are heated to the carbonization temperature for from about 10 min to about 180 min. In some embodiments, the petroleum feedstock and the carbonization catalyst are heated to the carbonization temperature for from about 15 min to about 150 min. In some embodiments, the petroleum feedstock and the carbonization catalyst are heated to the carbonization temperature for from about 20 min to about 120 min. In some embodiments, the petroleum feedstock and the carbonization catalyst are heated to the carbonization temperature for from about 25 min to about 90 min. In some embodiments, the petroleum feedstock and the carbonization catalyst are heated to the carbonization temperature for from about 30 min to about 60 min. In some embodiments, the petroleum feedstock and the carbonization catalyst are heated to the carbonization temperature for from about 35 min to about 50 min. In some embodiments, the petroleum feedstock and the carbonization catalyst are heated to the carbonization temperature for from about 40 min to about 45 min.

In some embodiments, the petroleum feedstock and the carbonization catalyst are heated to the carbonization temperature for about 5 min, about 10 min, about 15 min, about 20 min, about 25 min, about 30 min, about 35 min, about 40 min, about 45 min, about 50 min, about 55 min, about 60 min, about 90 min, about 120 min, about 150 min, about 180 min, about 210 min, or about 240 min.

In some embodiments, the petroleum feedstock and the carbonization catalyst are heated to the carbonization temperature for from about 30 min, about 35 min, about 40 min, about 45 min, about 50 min, about 55 min, or about 60 min.

In some embodiments, the petroleum feedstock and the carbonization catalyst are heated to the carbonization temperature for about 5 min. In some embodiments, the petroleum feedstock and the carbonization catalyst are heated to the carbonization temperature for about 10 min. In some embodiments, the petroleum feedstock and the carbonization catalyst are heated to the carbonization temperature for about 15 min. In some embodiments, the petroleum feedstock and the carbonization catalyst are heated to the carbonization temperature for about 20 min. In some embodiments, the petroleum feedstock and the carbonization catalyst are heated to the carbonization temperature for about 25 min. In some embodiments, the petroleum feedstock and the carbonization catalyst are heated to the carbonization temperature for about 30 min. In some embodiments, the petroleum feedstock and the carbonization catalyst are heated to the carbonization temperature for about 35 min. In some embodiments, the petroleum feedstock and the carbonization catalyst are heated to the carbonization temperature for about 40 min. In some embodiments, the petroleum feedstock and the carbonization catalyst are heated to the carbonization temperature for about 45 min. In some embodiments, the petroleum feedstock and the carbonization catalyst are heated to the carbonization temperature for about 50 min. In some embodiments, the petroleum feedstock and the carbonization catalyst are heated to the carbonization temperature for about 55 min. In some embodiments, the petroleum feedstock and the carbonization catalyst are heated to the carbonization temperature for about 60 min. In some embodiments, the petroleum feedstock and the carbonization catalyst are heated to the carbonization temperature for about 90 min. In some embodiments, the petroleum feedstock and the carbonization catalyst are heated to the carbonization temperature for about 120 min. In some embodiments, the petroleum feedstock and the carbonization catalyst are heated to the carbonization temperature for about 150 min. In some embodiments, the petroleum feedstock and the carbonization catalyst are heated to the carbonization temperature for about 180 min. In some embodiments, the petroleum feedstock and the carbonization catalyst are heated to the carbonization temperature for about 210 min. In some embodiments, the petroleum feedstock and the carbonization catalyst are heated to the carbonization temperature for about 240 min.

In some embodiments, the petroleum feedstock and the carbonization catalyst are heated at a pressure of about 1 bar. In some embodiments, the petroleum feedstock and the carbonization catalyst are heated at a pressure of greater than about 1 bar.

In some embodiments, the sulfur-doped carbon is formed in a yield of about 5% to about 50%. In some embodiments, the sulfur-doped carbon is formed in a yield of about 10% to about 30%. In some embodiments, the sulfur-doped carbon is formed in a yield of about 10% to about 20%. In some embodiments, the sulfur-doped carbon is formed in a yield of about 10% to about 30%.

In some embodiments, the sulfur-doped carbon has a sulfur-content of about 0.01% to about 20.00%. In some embodiments, the sulfur-doped carbon has a sulfur-content of about 0.50% to about 15.00%. In some embodiments, the sulfur-doped carbon has a sulfur-content of about 1.00% to about 10.00%.

In some embodiments, the petroleum feedstock and the carbonization catalyst are heated in the presence of one or more additives, selected from potassium chloride, potassium hydroxide, elemental sulfur, or a combination thereof. In some embodiments, the additive is potassium chloride, potassium hydroxide, or a combination thereof. In some embodiments, the additive is elemental sulfur, and the sulfur-doped carbon includes a higher sulfur content compared to the sulfur-doped carbon formed when the petroleum feedstock and the carbonization catalyst are heated without elemental sulfur.

In some embodiments, the petroleum feedstock includes atmospheric residue, light vacuum gas oil (VGO), heavy vacuum gas oil (VGO), vacuum residue, or combinations thereof. In some embodiments, the petroleum feedstock includes atmospheric residue. In some embodiments, the petroleum feedstock includes light vacuum gas oil (VGO). In some embodiments, the petroleum feedstock includes heavy vacuum gas oil (VGO). In some embodiments, the petroleum feedstock includes vacuum residue. In some embodiments, the petroleum feedstock includes atmospheric residue, light vacuum gas oil (VGO), heavy vacuum gas oil (VGO), and vacuum residue. In some embodiments, the petroleum feedstock includes light vacuum gas oil (VGO), heavy vacuum gas oil (VGO), and vacuum residue. In some embodiments, the petroleum feedstock includes atmospheric residue, heavy vacuum gas oil (VGO), and vacuum residue. In some embodiments, the petroleum feedstock includes atmospheric residue, light vacuum gas oil (VGO), and vacuum residue. In some embodiments, the petroleum feedstock includes atmospheric residue, light vacuum gas oil (VGO), and heavy vacuum gas oil (VGO). In some embodiments, the petroleum feedstock includes atmospheric residue and light vacuum gas oil (VGO). In some embodiments, the petroleum feedstock includes atmospheric residue and heavy vacuum gas oil (VGO). In some embodiments, the petroleum feedstock includes atmospheric residue and vacuum residue. In some embodiments, the petroleum feedstock includes light vacuum gas oil (VGO) and heavy vacuum gas oil (VGO). In some embodiments, the petroleum feedstock includes light vacuum gas oil (VGO) and vacuum residue. In some embodiments, the petroleum feedstock includes heavy vacuum gas oil (VGO) and vacuum residue.

In some embodiments, the method of thermal carbonization further includes providing a petroleum feedstock in a vessel. In some embodiments, the method of thermal carbonization further includes heating the petroleum feedstock to a pour point temperature. In some embodiments, the method of thermal carbonization further includes adding a carbonization catalyst to the petroleum feedstock. In some embodiments, the method of thermal carbonization further includes purging oxygen from the vessel with nitrogen. In some embodiments, the method of thermal carbonization further includes heating the petroleum feedstock and carbonization catalyst to a carbonization temperature to form a sulfur-doped carbon. In some embodiments, the method of thermal carbonization further includes isolating the sulfur-doped carbon. In some embodiments, the method of thermal carbonization further includes washing the sulfur-doped carbon to provide a purified sulfur-doped carbon. In some embodiments, the method of thermal carbonization further includes regenerating the carbonization catalyst.

In some embodiments, the method of thermal carbonization includes the following steps:
providing a petroleum feedstock in a vessel;
heating the petroleum feedstock to a pour point temperature;
adding a carbonization catalyst to the petroleum feedstock;
purging oxygen from the vessel with an inert gas;
heating the petroleum feedstock and carbonization catalyst to a carbonization temperature to form a sulfur-doped carbon;
isolating the sulfur-doped carbon;
washing the sulfur-doped carbon to provide a purified sulfur-doped carbon;
where the petroleum feedstock includes one or more sulfur-containing compounds, and the carbonization catalyst is an acetate, a bicarbonate, a bromide, a carbonate, a chloride, a fluoride, an oxalate salt, or a combination thereof.

In some embodiments, the pour point temperature is from about 25° C. to about 100° C. In some embodiments, the pour point temperature is from about 30° C. to about 75° C. In some embodiments, the pour point temperature is from about 35° C. to about 50° C. In some embodiments, the pour point temperature is from about 40° C. to about 45° C. In some embodiments, the pour point temperature is from about 35° C. to about 40° C.

In some embodiments, the pour point temperature is about 25° C. In some embodiments, the pour point temperature is about 30° C. In some embodiments, the pour point temperature is about 35° C. In some embodiments, the pour point temperature is about 40° C. In some embodiments, the pour point temperature is about 45° C. In some embodiments, the pour point temperature is about 50° C. In some embodiments, the pour point temperature is about 60° C. In some embodiments, the pour point temperature is about 70° C. In some embodiments, the pour point temperature is about 80° C. In some embodiments, the pour point temperature is about 90° C. In some embodiments, the pour point temperature is about 100° C.

In some embodiments, the inert gas is nitrogen.

### EXAMPLES

### Example 1. General Method for Thermal Carbonization of Petroleum Feedstock

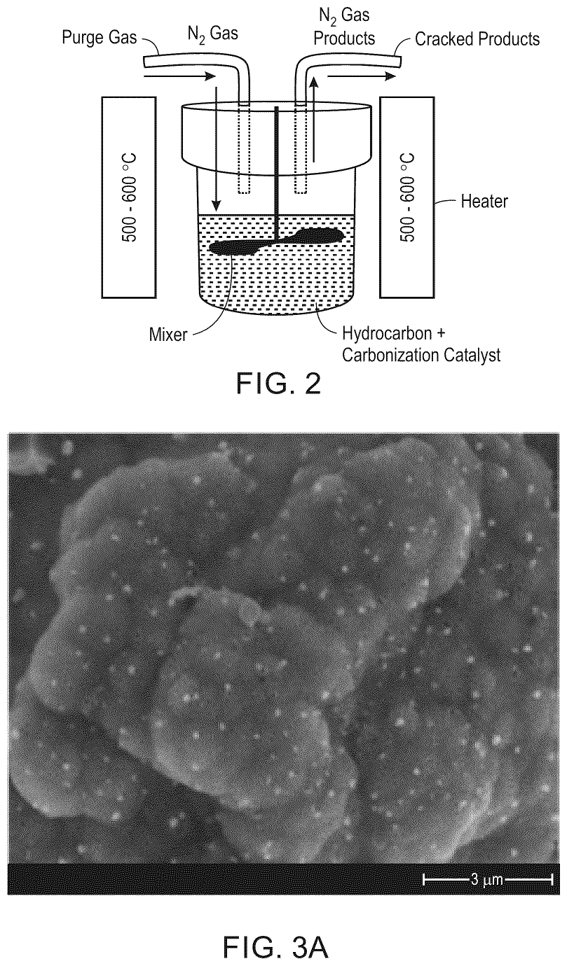

Carbonization catalyst (K₂CO₃, 100 g) mixed with vacuum residue (100 g) that was heated to 40° C. in a heating vessel (FIG. 2). The mixture was loaded into the reactor before purging with nitrogen gas (100 mL/min for 40 min) to remove oxygen from the atmosphere. Then the reactor heated at 20° C./min to 600° C. for 40 min to allow for the carbonization reaction to be completed. After the reaction, the mixture was allowed to cool to room temperature before washing the product with water to remove the carbonization catalyst.

### Example 2. Characterization of Sulfur-Doped Carbon Obtained from Thermal Carbonization

The general method for thermal carbonization of petroleum feedstock was performed on atmospheric residue and vacuum residue petroleum feedstocks.

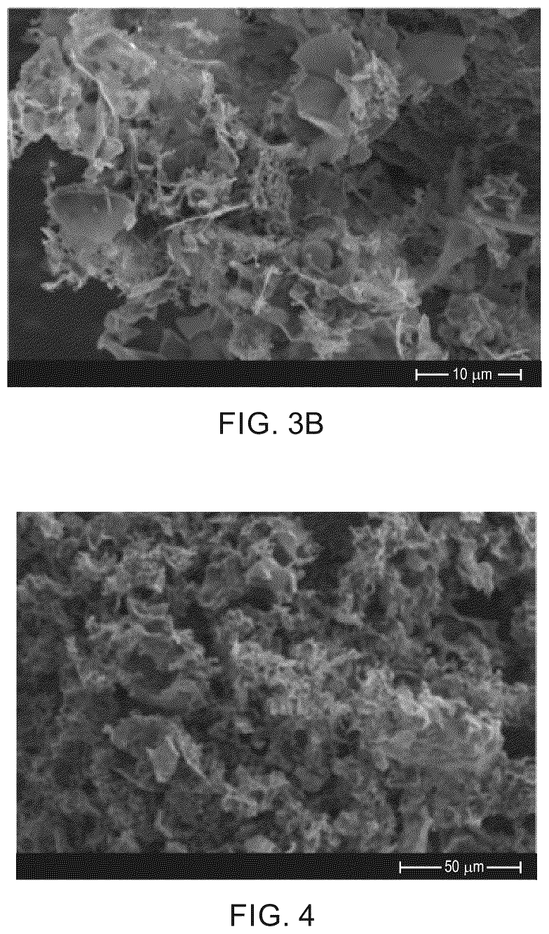

Scanning electron microscope (SEM) images of the obtained sulfur-doped carbon sample showed a porous structure of the formed sulfur-doped carbon products obtained from both atmospheric residue (FIG. 3A and FIG. 3B) and vacuum residue (FIG. 4).

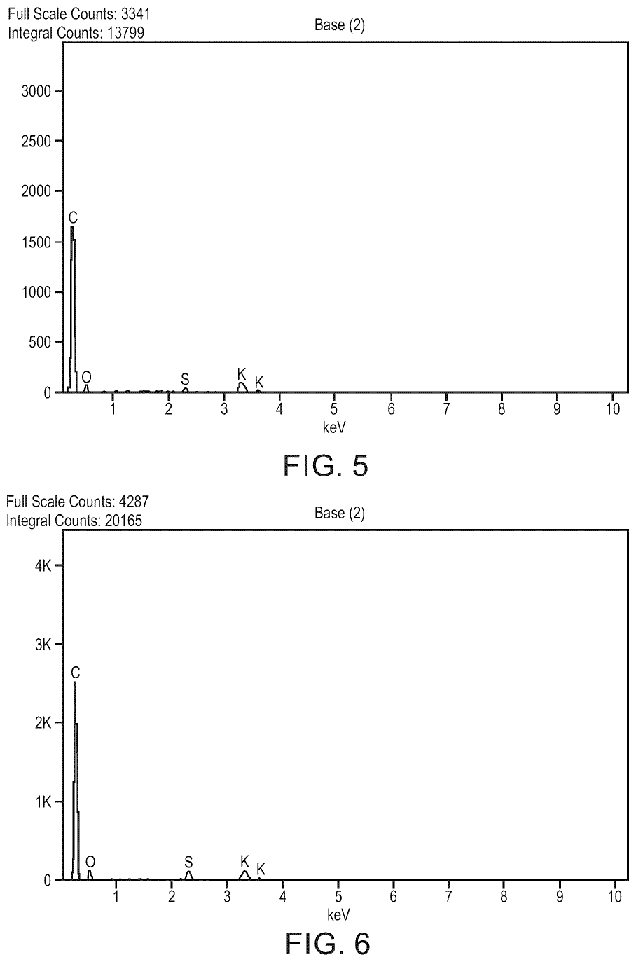

The sulfur content was determined using energy dispersive X-ray spectroscopy (EDS) for the sulfur-doped carbon obtained from atmospheric residue as being between about 1 wt % to about 5 wt % (FIG. 5). The sulfur content of the sulfur-doped carbon obtained from vacuum residue was between 4 wt % and 10 wt % (FIG. 6) confirming the presence of sulfur in the carbon matrix.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of thermal carbonization, the method comprising:
heating a petroleum feedstock and a carbonization catalyst to a carbonization temperature to form a sulfur-doped carbon;
wherein the petroleum feedstock comprises one or more sulfur-containing compounds, and the carbonization catalyst is an acetate, a bicarbonate, a bromide, a carbonate, a chloride, a fluoride, an oxalate salt, or a combination thereof.

2. The method of claim 1, wherein the carbonization catalyst is potassium acetate, potassium bicarbonate, potassium carbonate, potassium chloride, potassium oxalate, calcium acetate, calcium bicarbonate, calcium carbonate, calcium chloride, calcium oxalate, sodium acetate, sodium bicarbonate, sodium carbonate, sodium chloride, sodium oxalate, sodium fluoride, potassium fluoride, sodium bromide, potassium bromide, or a combination thereof.

3. The method of claim 2, wherein the carbonization catalyst is potassium acetate, potassium bicarbonate, potassium carbonate, potassium chloride, potassium oxalate, or a combination thereof.

4. The method of claim 3, wherein the carbonization catalyst is potassium carbonate.

5. The method of claim 1, wherein about 0.25 equivalents to about 4.00 equivalents of carbonization catalyst are used relative to the petroleum feedstock.

6. The method of claim 1, wherein about 1.00 equivalents of carbonization catalyst are used relative to the petroleum feedstock.

7. The method of claim 1, wherein the carbonization temperature is about 450° C. to about 800° C.

8. The method of claim 5, wherein the carbonization temperature is about 500° C. to about 700° C.

9. The method of claim 7, wherein the petroleum feedstock and the carbonization catalyst are heated to the carbonization temperature for about 5 min to about 240 min.

10. The method of claim 9, wherein the petroleum feedstock and the carbonization catalyst are heated to the carbonization temperature for about 40 min.

11. The method of claim 1, wherein the petroleum feedstock and the carbonization catalyst are heated at a pressure of about 1 bar.

12. The method of claim 1, wherein the sulfur-doped carbon is formed in a yield of about 5% to about 50%.

13. The method of claim 1, wherein the sulfur-doped carbon is formed in a yield of about 10% to about 30%.

14. The method of claim 1, wherein the sulfur-doped carbon is formed in a yield of about 10% to about 20%.

15. The method of claim 1, wherein the sulfur-doped carbon has a sulfur-content of about 0.1 wt % to about 20.00%.

16. The method of claim 15, wherein the sulfur-doped carbon has a sulfur-content of about 0.50 wt % to about 15.00 wt %.

17. The method of claim 16, wherein the sulfur-doped carbon has a sulfur-content of about 1.00 wt % to about 10.00 wt %.

18. The method of claim 1, wherein the petroleum feedstock and the carbonization catalyst are heated in the presence of one or more additives, selected from potassium chloride, potassium hydroxide, elemental sulfur, or a combination thereof.

19. The method of claim 18, wherein the additive is potassium chloride, potassium hydroxide, or a combination thereof.

20. The method of claim 18, wherein the additive is elemental sulfur, and the sulfur-doped carbon comprises a higher sulfur content compared to the sulfur-doped carbon formed when the petroleum feedstock and the carbonization catalyst are heated without elemental sulfur.

21. The method of claim 1, wherein the petroleum feedstock comprises one or more of atmospheric residue, light vacuum gas oil (VGO), heavy vacuum gas oil (VGO), and vacuum residue.

22. A method of thermal carbonization, the method comprising:
providing a petroleum feedstock in a vessel;
heating the petroleum feedstock to a pour point temperature;
adding a carbonization catalyst to the petroleum feedstock;
purging oxygen from the vessel with nitrogen;
heating the petroleum feedstock and carbonization catalyst to a carbonization temperature to form a sulfur-doped carbon;
isolating the sulfur-doped carbon;
washing the sulfur-doped carbon to provide a purified sulfur-doped carbon;
wherein the petroleum feedstock comprises one or more sulfur-containing compounds, and the carbonization catalyst is an acetate, bicarbonate, carbonate, chloride, or oxalate salt, or a combination thereof.

23. The method of claim 22, wherein the pour point temperature is about 25° C. to about 100° C.

24. The method of claim 23, wherein the pour point temperature is about 40° C.

25. The method of claim 22, wherein the method further comprises regenerating the carbonization catalyst.
